(19) United States
(12) Patent Application Publication
(10) Pub. No.: US 2012/0256885 A1
(43) Pub. Date: Oct. 11, 2012

(54) DISPLAY DEVICE HAVING NOISE REDUCTION FUNCTION AND NOISE REDUCTION METHOD

(76) Inventors: Hyeok-Tae KWON, Daegu Metropolitan City (KR); Hyun-Seop Song, Bucheon-si (KR)

(21) Appl. No.: 13/207,920

(22) Filed: Aug. 11, 2011

(30) Foreign Application Priority Data
Apr. 6, 2011 (KR) 10-2011-0031759

(51) Int. Cl. G09G 5/00; G06K 9/62

(52) U.S. Cl. 345/204; 382/209

(57) ABSTRACT

A display device has a noise reduction function. The display device includes a display panel, a data driver connected to the display panel, a gate driver connected to the display panel, and a signal controller. The signal controller controls the data driver and the gate driver, and includes an inversion determinator that is configured to select an inversion driving method based on an image pattern of input image data.

### CROSS-REFERENCE TO RELATED APPLICATION

This application claims priority to Korean Patent Application No. 10-2011-0031759 filed in the Korean Intellectual Property Office on Apr. 6, 2011, the disclosure of which is incorporated by reference herein.

### BACKGROUND

(a) Technical Field

Embodiments of the present invention relate to a display device having a noise reduction function and a noise reduction method.

(b) Discussion of the Related Art

A flat panel display device typically has a smaller thickness than cathode-ray tube and projection type display devices. A liquid crystal display is an example of a flat panel display device. A flat panel display device receives external image data from a signal controller, converts and transfers the received image data to a data driver, and transmits other control signals to the data driver, a gate driver, and a backlight unit to allow an image to be displayed on a display panel. However, a flat panel display device may produce noise when it operates.

A capacitor (hereinafter, referred to as a ‘stacked capacitor’) having a stacked structure such as a multi-layered ceramic capacitor (MLCC) in which layers are stacked may be one of the causes of the noise produced by the display device. A voltage is applied to each layer of the stacked capacitor by applying a voltage to both sides of the stacked capacitor to result in an electrostatic capacitance

When the voltage applied to both sides of the stacked capacitor is vibrated by a ripple, the voltage applied to each layer is also vibrated, and as a result, each layer is vibrated by a piezoelectric effect. Further, if a printed circuit board (PCB) is attached to the stacked capacitor, the PCB is also vibrated, thereby generating even more noise.

The noise produced by the display device may be reduced by replacing the stack capacitor with a polymer tantalum capacitor or condenser. Polymer tantalum capacitors can store a great deal of electricity given their weight and size. Further, since polymer tantalum capacitors do not have a stacked structure, they are less susceptible to vibrations caused by electrostatic force. However, since polymer tantalum capacitors can cost an average of 10 times more than stacked capacitors, their use can greatly increase the manufacturing cost of a display device.

### SUMMARY

At least one embodiment of the present invention provides a display device and a noise reduction method that can reduce noise generated from the display device even when only multi-layered ceramic capacitors are used. At least one embodiment of the present invention provides a display device and a noise reduction method in which noise is generated at a reference value or less even when only stacked capacitors are used.

An exemplary embodiment of the present invention provides a display device having a noise reduction function. The display device includes a display panel, a data driver connected to the display panel, a gate driver connected to the display panel, and a signal controller controlling the data driver and the gate driver, and including an inversion determinator that is configured to select an inversion method based on an image pattern of input image data.

The inversion determinator may include a pattern verifying unit that is configured to verify whether the image pattern displayed by the image data input into the inversion determinator is one of a plurality of image patterns, and an inversion method determining unit generating and outputting an inversion control signal that corresponds to the verified image pattern to invoke the selected driving method.

The pattern verifying unit may verify whether one pixel row among the input image data displays black or white.

The signal controller may further include a plurality of line memories, and a corresponding one of the line memories may generate unit pixel row data corresponding to one pixel row by rearranging the image data input into the signal controller.

The pattern verifying unit verifies whether all the unit pixel row data are 1 or 0 to judge whether the data are black or white.

The inversion method determining unit may store the plurality of image patterns and inversion methods, and when an image is displayed that is based on the verified image pattern and generates noise that is above a certain level by an inversion method stored as a default, the default inversion method may be changed to one of the other inversion methods.

In one of the image patterns stored in the inversion method determining unit, the black and white may be alternately displayed in rows.

In one of the inversion methods, an inverted data voltage is applied every two rows from the first row to an image pattern in which the black and white are alternately displayed every four pixel rows or an image pattern in which the black and white are alternately displayed every two pixel rows among the stored image patterns.

The pattern verifying unit may verify the pattern by using only six consecutive rows.

In one of the image patterns stored in the inversion method determining unit, the black and white may be alternately displayed in columns.

The device may further include a printed circuit board including a stacked capacitor, wherein at least one of the signal controller and the data driver is formed on the printed circuit board.

A polymer tantalum condenser may not be formed on the printed circuit board.

An exemplary embodiment of the present invention provides a noise reduction method including receiving image data from the outside, verifying whether an image pattern of the received image data corresponds to one of a plurality of stored image patterns, and changing an inversion method to one of a plurality of inversion methods based on the verified image pattern.

The verifying of the image pattern of the received image data may include measuring a variation amount of the received image data and verifying whether the image pattern of the image data exists among the stored image patterns in accordance with the measured variation amount.

In the stored image patterns, black and white may be alternately displayed in rows.

In one of the inversion methods, an inverted data voltage is applied every two rows from the first row to an image pattern in which the black and white are alternately displayed every four pixel rows or an image pattern in which the black and white are alternately displayed every two pixel rows among the stored image patterns.

In the verifying of the image pattern of the received image data, the pattern may be verified using only six consecutive rows.

According to an exemplary embodiment of the present invention, a display device includes a display panel to display images, a data driver to provide data voltages to the display panel, a gate driver to provide gate voltage to the display panel, and a signal controller controlling the data driver and the gate driver. The signal controller stores a plurality of image patterns and corresponding inversion driving methods. The signal controller is configured to compare a source image pattern of input image data with the plurality of image patterns, select one of the inversion driving methods based on a result of the comparison, and drive the data driver based on the selected inversion driving method. Each image pattern may include alternating rows of black and white or alternating columns of black and white. The driving methods may be distinct from one another and the image patterns may be distinct from one another.

### BRIEF DESCRIPTION OF THE DRAWINGS

FIG. 1 is a block diagram of a display device having a noise reduction function according to an exemplary embodiment of the present invention.

FIG. 2 is a block diagram of an inversion determinator according to an exemplary embodiment of the present invention.

FIG. 3 is a flowchart showing a noise reduction method according to an exemplary embodiment of the present invention.

FIGS. 4, 6, 8, 10, and 12 are image patterns for testing a display device according to an exemplary embodiment of the present invention.

FIGS. 5, 7, 9, 11, and 13 are graphs showing a result of testing a display device in each image pattern according to an exemplary embodiment of the present invention.

FIG. 14 is an example of an image pattern to generate noise according to an exemplary embodiment of the present invention.

FIG. 15 is a layout view of a display device having a noise reduction function according to an exemplary embodiment of the present invention.

FIG. 16 is a photograph showing a multi-layered ceramic capacitor and a polymer tantalum condenser attached to a printed circuit board.

### DETAILED DESCRIPTION

The present invention will be described more fully hereinafter with reference to the accompanying drawings, in which exemplary embodiments of the invention are shown. The described embodiments may be modified in various different ways, without departing from the spirit or scope of the disclosure.

In the drawings, the thickness of layers, films, panels, regions, etc., may be exaggerated for clarity. Like reference numerals designate like elements throughout the specification. It will be understood that when an element such as a layer, film, region, or substrate is referred to as being “on” another element, it can be directly on the other element or intervening elements may also be present.

As will be appreciated by one skilled in the art, aspects of the present invention may be embodied as a system, method, computer program product, or a computer program product embodied in one or more computer readable medium(s) having computer readable program code embodied thereon. The computer readable program code may be provided to a processor of a general purpose computer, special purpose computer, or other programmable data processing apparatus. The computer readable medium may be a computer readable signal medium or a computer readable storage medium. The computer readable storage medium may be any tangible medium that can contain, or store a program for use by or in connection with an instruction execution system, apparatus, or device.

Hereinafter, a display device having a noise reduction function and a noise reduction method according to at least one exemplary embodiment of the present invention will be described in detail with reference to the accompanying drawings.

For example, when a pattern of inputted image data is likely to generate noise, an inversion driving method may be changed to reduce the noise caused by a capacitor within the display device (e.g., a stacked capacitor).

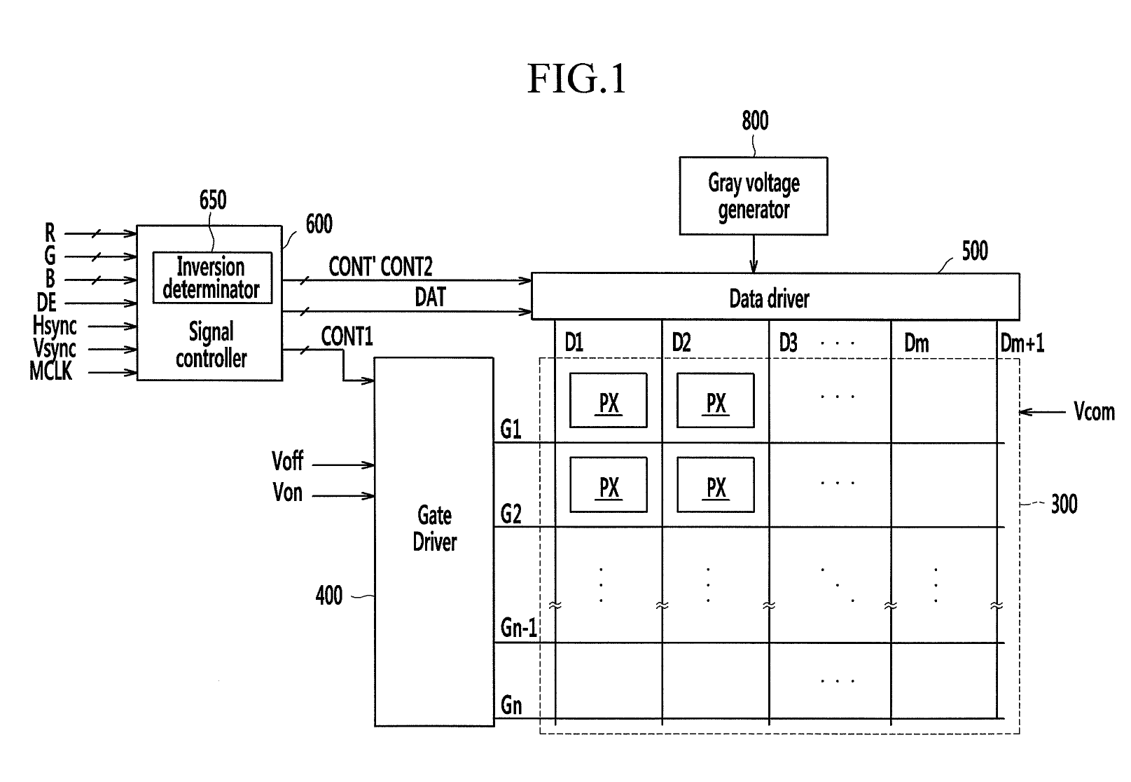

The inversion method can be changed by adding logic to a signal controller of the display device (see reference numeral 600 of FIG. 1) without adding an additional component. The logic may be added to an integrated circuit or IC chip of the signal controller.

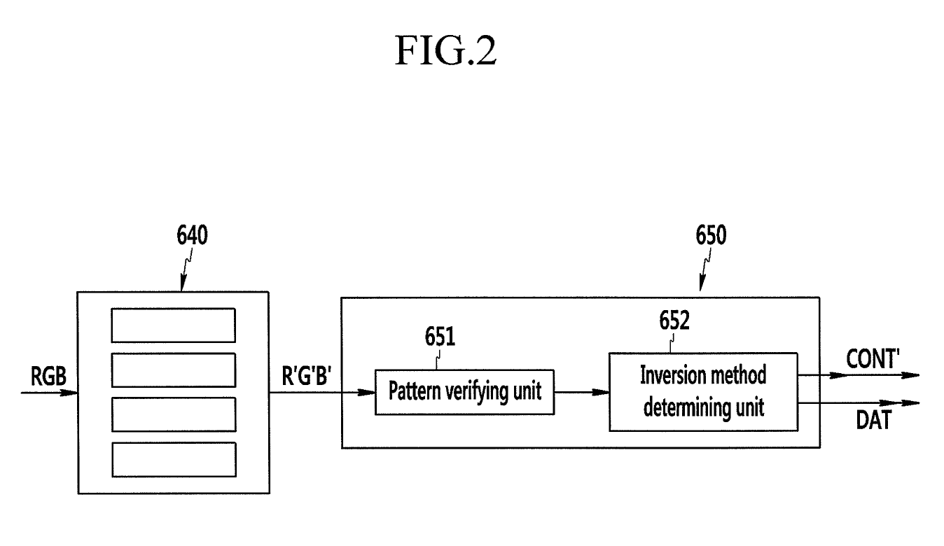

FIG. 1 is a block diagram of a display device having a noise reduction function according to an exemplary embodiment of the present invention. FIG. 2 is a block diagram of an inversion determinator 650 according to an exemplary embodiment of the present invention, which may be used in a signal controller 600 of FIG. 1.

The inversion determinator 650 selects an inversion driving method based on a pattern of image data. The image data may be input from an external source. While FIG. 1 shows the inversion determinator 650 being located within a signal controller 600, in alternate embodiments, the inversion determinator 650 may be located outside the signal controller 600 or within a data driver 500. When the inversion determinator 650 is located within the signal controller 600, the entire signal controller 600 may be located on a single integrated circuit and the inversion determinator 650 may be formed by a series of logic circuits on the integrated circuit.

The inversion determinator 650 according to an exemplary embodiment of the present invention includes a pattern verifying unit 651 and an inversion method determining unit 652 (see FIG. 2).

Referring to FIGS. 1 and 2, image data R, G, and B is transferred to the signal controller 600. The image data R, G, B may be input from an external source. The signal controller 600 converts the input image data R, G, and B into an appropriate format and transfers the converted image data DAT to the data driver 500. The signal controller 600 also transfers control signals CONT1 and CONT2 respectively to a gate driver 400 and the data driver 500 for controlling the drivers.

The image data R, G, and B input into the signal controller 600 may be transferred to one or more line memories 640 to rearrange data of the input image data R, G, and B. While four line memories are shown in FIG. 2, alternate embodiments may have a lesser or greater number of line memories. The image data R, G, and B input into a corresponding one of the line memories 640 may be stored according to a predetermined sequence. As a result, an arrangement sequence of the image data R, G, and B input is converted into that of image data used in the display device. In an exemplary embodiment of the invention, the rearranged image data R′, G′, and B′ is rearranged so that image data to be applied to one pixel row is stored in one line memory. Herein, the image data corresponding to the one pixel row stored in the one line memory will be referred to as ‘unit pixel row data’.

The image data R′, G′, and B′ rearranged through a corresponding one of the line memories 640 is input into the inversion determinator 650. In at least one exemplary embodiment, an image data converter (not shown) is additionally provided between the line memories 640 and the inversion determinator 650, and as a result, additionally converted data may be input into the inversion determinator 650.

The rearranged image data R′, G′, and B′ input into the inversion determinator 650 is input into the pattern verifying unit 651 to verify which pattern an image to be displayed has. In an exemplary embodiment, data from several (e.g., six) unit pixel rows among the rearranged image data R′, G′, and B′ input through the line memories 640 are compared with each other to verify the pattern. The pattern verifying unit 651 according to an exemplary embodiment of the present invention verifies the pattern using a method of determining whether luminances indicated by the unit pixel row data are all black or white.

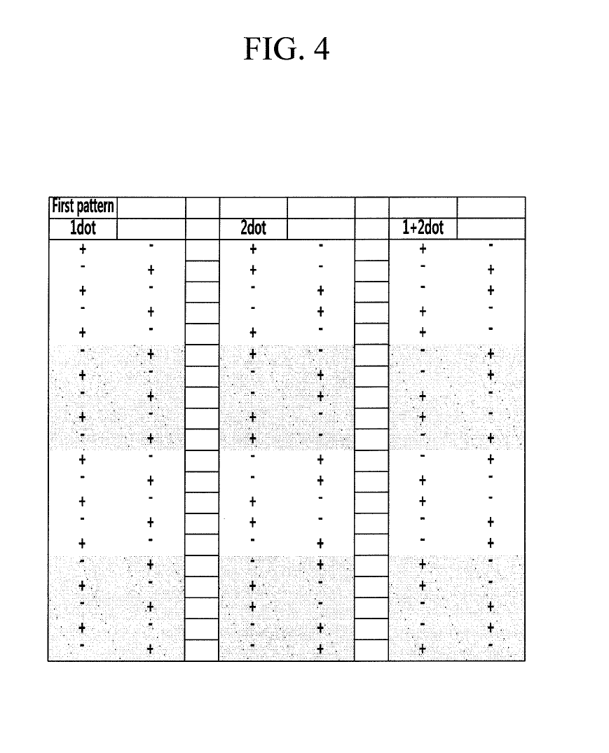

The method of verifying the pattern of the image data according to the exemplary embodiment of the present invention will be described in more detail below. For example, data of each pixel in a unit pixel row may be checked in sequence to determine whether they are all 0s or all 1s. When several consecutive unit pixel rows are all set to 1 or 0 (e.g., six rows), it is verified whether the image data corresponds to a pattern that is likely to produce noise when displayed. For example, FIGS. 4, 6, 8, 10, and 12 (hereinafter, referred to as the ‘five image patterns’) illustrate examples of patterns that may produce noise when displayed. One or more of the corresponding patterns may be stored within the display device to enable the pattern verifying unit 651 to verify whether the image data corresponds to the patterns.

Since one row displays only a black color or a white color in the five image patterns, the pattern may be verified by determining whether all the data of one unit pixel row are 0 or 1. In a normally black display device, when all data of one unit pixel row are 0, one unit pixel row displays black, which is the lowest gray and when all the data are 1, the one unit pixel row displays white, which is the highest gray.

When 0 and 1 are present in data of a unit pixel row, the corresponding patterns differ from the five stored image patterns. As a result, the corresponding patterns do not match the stored patterns, and thus a default inversion driving method is performed.

As described above, the pattern of the image data is verified through the pattern verifying unit 651 and thereafter, the inversion method determining unit 652 uses the verified pattern to determine the appropriate inversion driving method. In the inversion method determining unit 652 according to an exemplary embodiment of the present invention, the image pattern and the inversion method in which the noise is generated from the corresponding image pattern are stored. As a result, a determination is made as to whether noise generated from a verified pattern equals or exceeds a reference noise level when a current inversion driving method is applied. When the noise equals or exceeds the reference noise level, the inversion method may be changed to a more suitable one for suppressing noise by changing an inversion control signal CONT′.

For example, in the display device, a default inversion driving method may be used initially and changed to a different inversion method if the corresponding inversion method and the verified pattern cause noise, or maintained otherwise.

A 1+2dot inversion driving method being used as the default will be described in the below example. The 1+2dot inversion driving method is shown in FIG. 4. In a general 2dot inversion driving method, inversion occurs every two rows downwards from a first row. In a 1+2dot driving inversion method, the inversion occurs in a second row just below the first row and the inversion occurs every two rows therebelow. Therefore, the 1+2dot inversion method is a combination of 1 row inversion and 2dot inversion. Further, in both the 1+2dot inversion and the 2dot inversion, an inversion occurs every column.

When a large amount of noise is generated in driving using the 1+2dot inversion method, the inversion method determining unit 652 transfers the inversion control signal CONT′ to convert the 1+2dot inversion method into a method (e.g., a 1dot inversion method or a 2dot inversion method), which generates less noise to the data driver 500. The type of display device may used as a factor in determining whether a large amount of noise will be generated. Further, when the image data varies significantly, the resulting variation in the magnitude of the voltage may cause the noise to be generated. Therefore, in at least one embodiment of the invention, a determination is made as to whether the noise is generated using tests for various image patterns and inversion methods suitable for reducing noise for one or more of the patterns is stored.

The image data R′, G′, and B′ input into the pattern verifying unit 651 does not need to pass through the inversion method determining unit 652. For example, the image data R′, G′, B′ can bypass the inversion method determining unit 652 for output as the image data DAT. When the image data R′, G′, B′ is input into the pattern verifying unit 651, the image data R′, G′, and B′ may be individually input into an additional data converter (not shown) and thereafter, may be converted and output as the image data DAT. In this example, the inversion method determining unit 652 generates and outputs only the inversion control signal CONT′ to change the inversion method according to a verification result of the pattern verifying unit 651.

Further, in at least one exemplary embodiment of the present invention, the image data R′, G′, and B′, from which the inversion method is determined in the inversion method determining unit 650, may be transferred to the data driver 500 as the type of the image data DAT through the additional data converter (not shown).

Referring to FIG. 1, a display device includes a panel assembly (also referred to as a ‘display panel’) 300, a gate driver 400 and a data driver 500 connected to the display panel 300, a gray voltage generator 800 connected to the data driver 500, and a signal controller 600 controlling the gate driver 400 and the gate driver 400.

The panel assembly 300 includes a plurality of gate lines G1 to Gn, a plurality of data lines D1 to Dm, and a plurality of pixels PX connected thereto. The pixels PX may be arranged substantially in matrix when viewed as an equivalent circuit.

The signal controller 600 receives the image data R, G, and B and input control signals for controlling the display panel 300 of the display device. The image data R, G, and B and the control signals may be received from an external graphics controller (not shown). Examples of the input control signals include a vertical synchronization signal Vsync and a horizontal synchronization signal Hsync, a main clock MCLK, a data enable signal DE, etc.

The signal controller 600 processes the image data R, G, and B according to an operational condition of the panel assembly 300 (e.g., a liquid crystal panel assembly) based on the input control signals, generates a gate control signal CONT1, a data control signal CONT2, and an inversion control signal CONT′, sends the gate control signal CONT1 to the gate driver 400, and sends the data control signal CONT2, the inversion control signal CONT′, and the processed image signal DAT to the data driver 500.

The gate lines G1 to Gn transfer gate signals (also referred to as a “scan signals”) and the data lines D1 to Dm transfer data signals.

A common voltage Vcom for a common electrode or a sustain electrode may be applied to the panel assembly 300.

The gray voltage generator 800 may generate two pairs of gray voltage sets associated with transmittance of the pixels PX. One of two pairs has a positive value and the other has a negative value with respect to the common voltage Vcom.

The gate driver 400 is connected with the gate lines G1 to Gn of the panel assembly 300 (e.g., a liquid crystal panel assembly) to apply gate signals formed by a combination of a gate-on voltage Von and a gate-off voltage Voff to the gate lines G1 to Gn.

The data driver 500 is connected with the data lines D1 to Dm of the panel assembly 300 (e.g., a liquid crystal panel assembly), and selects a gray voltage from the gray voltage generator 800 and applies the selected gray voltage to the data lines D1 to Dm as the data signals.

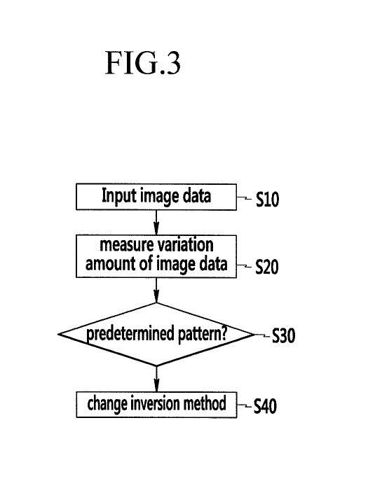

FIG. 3 is a flowchart showing a noise reduction method according to an exemplary embodiment of the present invention. Referring to FIG. 3, the image data is input (e.g., from an external source) (S10). The image data may be the same image data R, G, and B described above or the image data R′, G′, and B′ rearranged by the line memory described above according to some exemplary embodiments.

Next, variation amounts of the input image data R′ G′ and B′ are measured (S20). In at least one exemplary embodiment, it is verified whether data of one unit pixel row are data that display all white or all black (e.g., all 1s or all 0s).

Next, it is verified whether a pattern of the input image data is the same as previously stored image patterns by using the measured results for data of several unit pixel rows (S30). In some exemplary embodiments, the measuring and the verification steps (S20 and S30) are performed as one step.

If it is determined that the same pattern exists, the inversion method is changed, otherwise the inversion method determined as the default is maintained (S40). The method may be performed by a computer, a processor, etc., or stored as instructions or steps on a non-transitory computer readable medium (e.g., a floppy, a CD ROM, a flash drive, etc.).

While five previously stored image patterns are described below, in alternate embodiments, a lesser or greater number of image patterns may be used.

Hereinafter, a result of testing a noise level depending on the inversion method on the basis of the five image patterns will be described with reference to FIGS. 4 to 13.

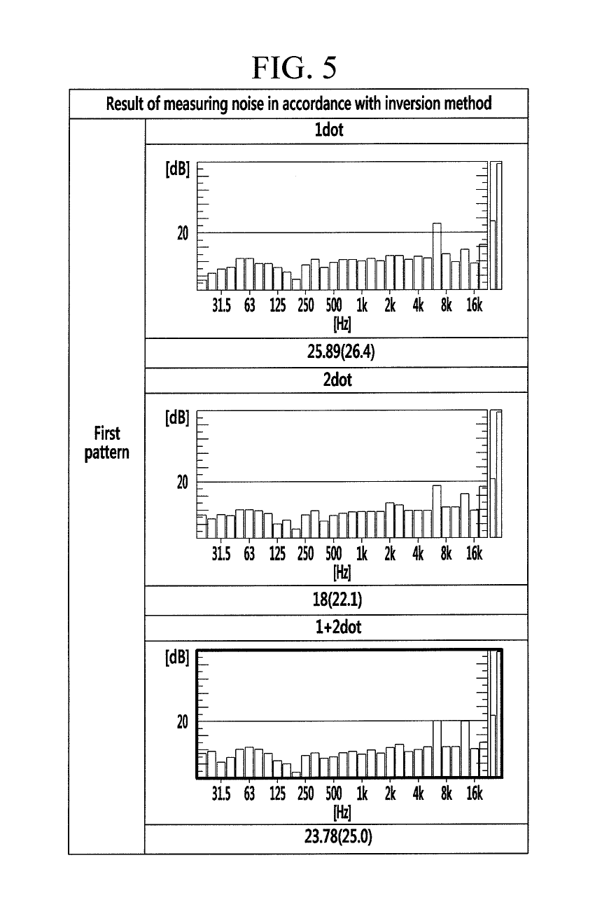

FIGS. 4, 6, 8, 10, and 12 are image patterns for testing a display device according to an exemplary embodiment of the present invention and FIGS. 5, 7, 9, 11, and 13 are graphs showing a result of testing a display device in each image pattern according to an exemplary embodiment of the present invention.

In the first image pattern shown in FIG. 4, white and black are alternately displayed every five pixel rows. Three types of inversion methods are applied to the first image pattern and shown in FIG. 4. In FIG. 4, + represents an example in which the white or black is displayed as positive polarity and − represents an example in which the white or black is displayed as negative polarity. Herein, 1dot represents polarity inversion in which polarity is inverted every one row and polarity is inverted every one column in a column direction. 2dot represents polarity inversion in which polarity is inverted every two rows and polarity is inverted every one column in the column direction. 1+2dot is similar to 2dot, but inversion is made in the second row just below the first row and polarity is inverted every two rows therebelow.

FIG. 5 shows a result of measuring noise by applying each inversion driving method. When inversion is performed for the first image pattern by the 1dot method, the noise is higher than a reference decibel (e.g., 20 dB) at 8 KHz or less and when inversion is performed for the first image pattern by the 2dot method and the 1+2dot method, the noise is not larger than the reference decibel. However, the noise is lower when the inversion is performed by the 2dot method as compared to when the inversion is performed by the 1+2dot method. Therefore, when using the first image pattern, when the inversion is performed by the 2dot or 1+2dot method rather than the 1dot method, the noise is reduced. In an exemplary embodiment of the present invention, since the 1+2dot inversion method is set as the default, the noise is not larger than the reference value in spite of not changing the inversion method. However, in FIG. 5, since the lower noise is generated when the inversion is performed by the 2dot method, the inversion method may be changed to the 2dot method in some exemplary embodiments.

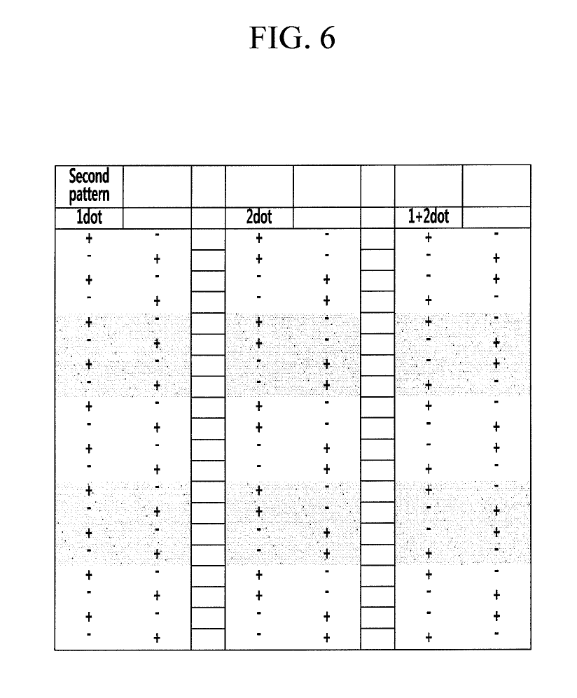

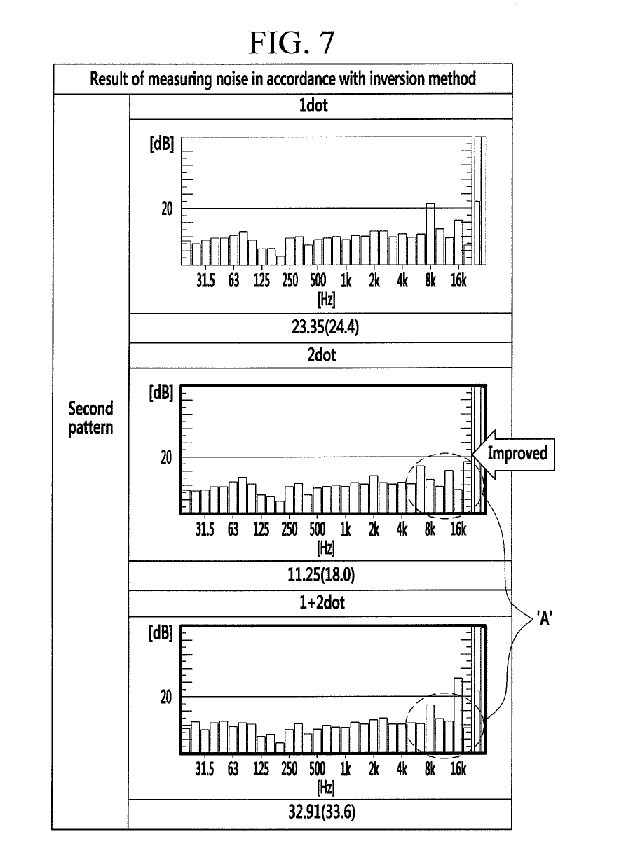

In the second image pattern of FIG. 6, the white and black are alternately displayed every four pixel rows. A result of testing the noise by applying polarity inversion to the second image pattern is shown in FIG. 7.

Referring to FIG. 7, when the 1+2dot inversion is applied, noise which is much larger than the reference value (e.g., 20 dB) at approximately 16 KHz is generated and even when the 1dot inversion is applied, the noise is larger than the reference value (e.g., 20 dB) at approximately 8 KHz. However, in the example of the 2dot inversion, the noise is not larger than the reference value. Therefore, in this example, the 2dot inversion method can be used instead of the 1+2dot or 1dot inversion methods to reduce noise. For example, if the 1+2dot inversion method is used as the default, noise can be reduced by changing the inversion method to the 2dot inversion method.

Referring back to FIG. 6, in the second image pattern, since polarity is changed only once while the same color is displayed as the white or black in the example of the 2dot inversion, noise may be reduced. In 1dot inversion, the polarity is changed three times while the same color is displayed and in 1+2dot inversion, the polarity is changed twice. As the polarity is more frequently changed, a variation of the data voltage is generated, and as a result, the noise increases. As a result, in at least one exemplary embodiment of the present invention, the inversion method is just changed from the 1+2dot inversion to the 2dot inversion to reduce the noise (see part ‘A’ of FIG. 7).

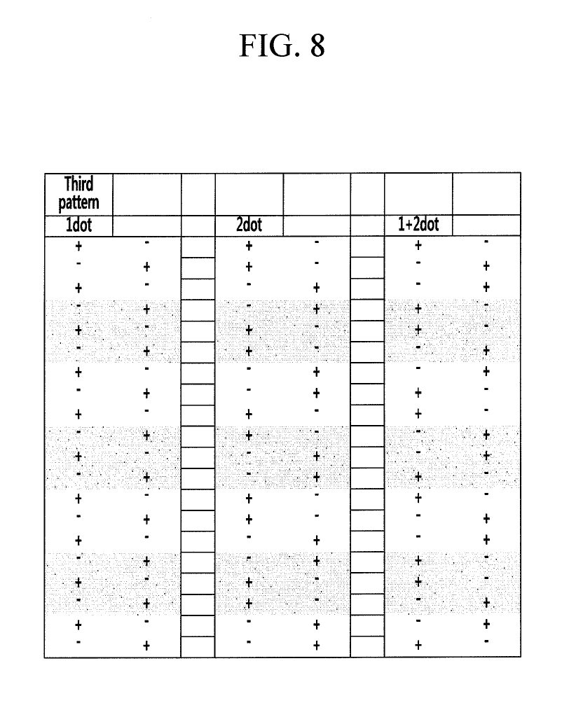

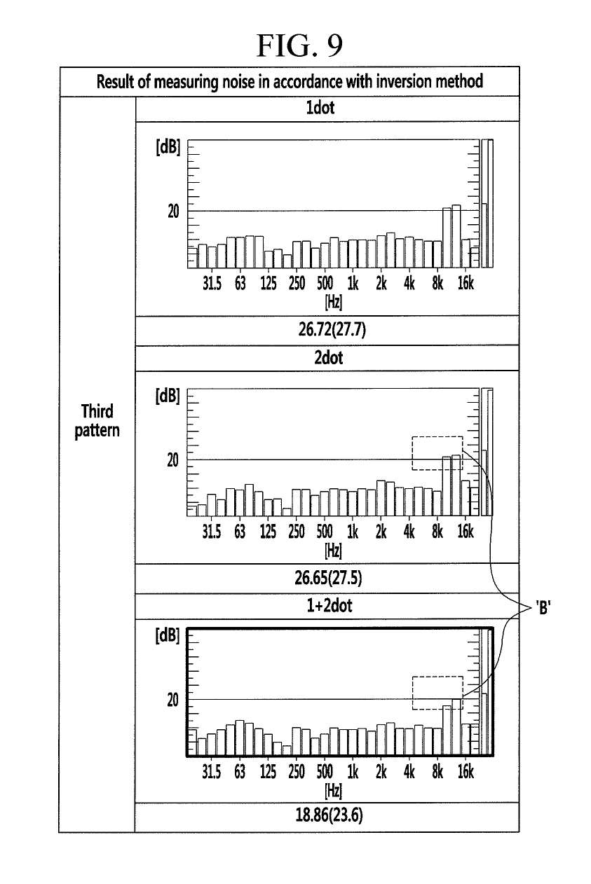

In the third image pattern of FIG. 8, the white and black are alternately displayed every three pixel rows. A result of testing the noise by applying polarity inversion to the third image pattern is shown in FIG. 9.

Referring to FIG. 9, noise of a relatively high level is generated at a frequency between 8 KHz and 16 KHz, and in the example of the 1dot and 2dot inversions, the noise is slightly larger than the reference value (e.g., 20 dB) and in the example of the 1+2dot inversion, the noise is not larger than the reference value. Therefore, the 1+2dot inversion method can be used as the method for reducing the noise for the third image pattern and when the 1+2dot inversion method is used as the default, the inversion method does not need to be changed. Part B of FIG. 9 shows an example in which the noise is lower in 1+2dot inversion method than the 2dot inversion method. FIG. 9 differs from FIG. 7 in this regard. For example, the noise is lower in the 2dot inversion method in FIG. 7 as compared to FIG. 9. For example, when the noise is not reduced by one inversion method another inversion method can be used to reduce the noise. The inversion methods for reducing the noise are different from each other depending on the image pattern. As a result, an additional test is performed and data is accumulated with respect thereto. The data accumulated by the test is stored in a memory to change the inversion method depending on the image pattern, thereby removing the noise.

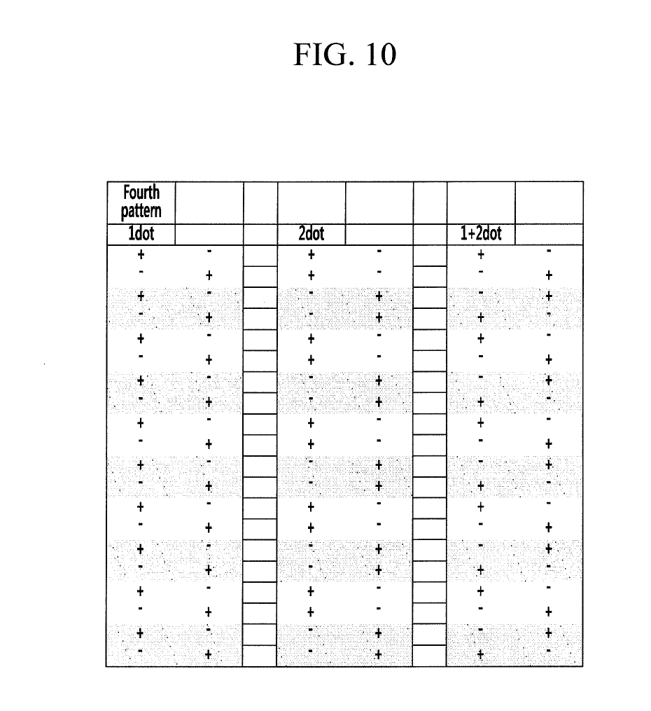

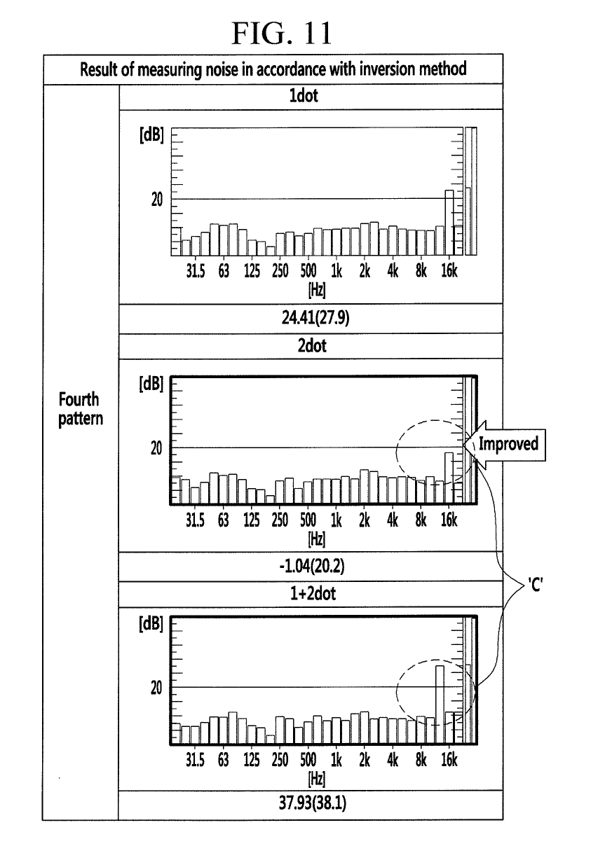

In the fourth image pattern of FIG. 10, the white and black are alternately displayed every two pixel rows. A result of testing the noise by applying polarity inversion to the fourth image pattern is shown in FIG. 11.

Referring to FIG. 11, when the 1+2dot inversion is applied, noise which is much larger than the reference value (e.g., 20 dB) at 16 KHz or less is generated and even when the 1dot inversion is applied, the noise is larger than 20 dB at approximately 16 KHz. However, in the example of the 2dot inversion, the noise is not larger than the reference value. The noise may be reduced when the inversion method is changed from the 1+2dot inversion to the 2dot inversion in the example of the fourth image pattern (see part ‘C’ of FIG. 11). For example, when the 1+2dot inversion method is used as the default, the inversion method can be changed to the 2dot inversion method to reduce the noise.

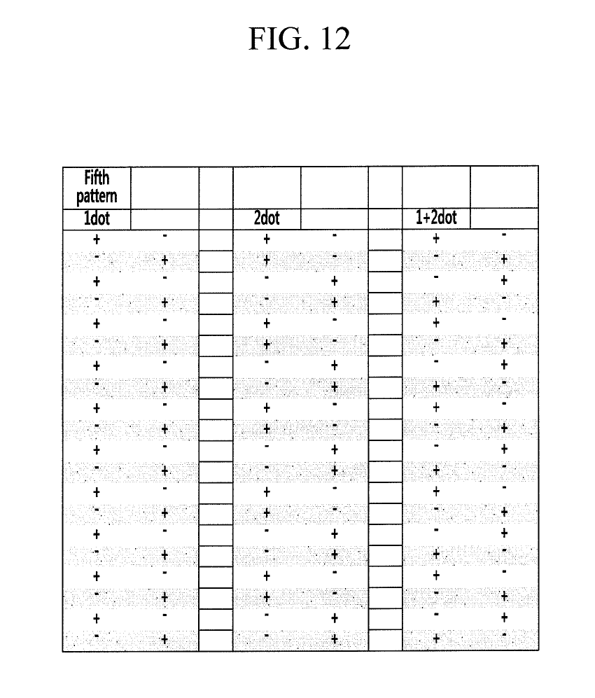

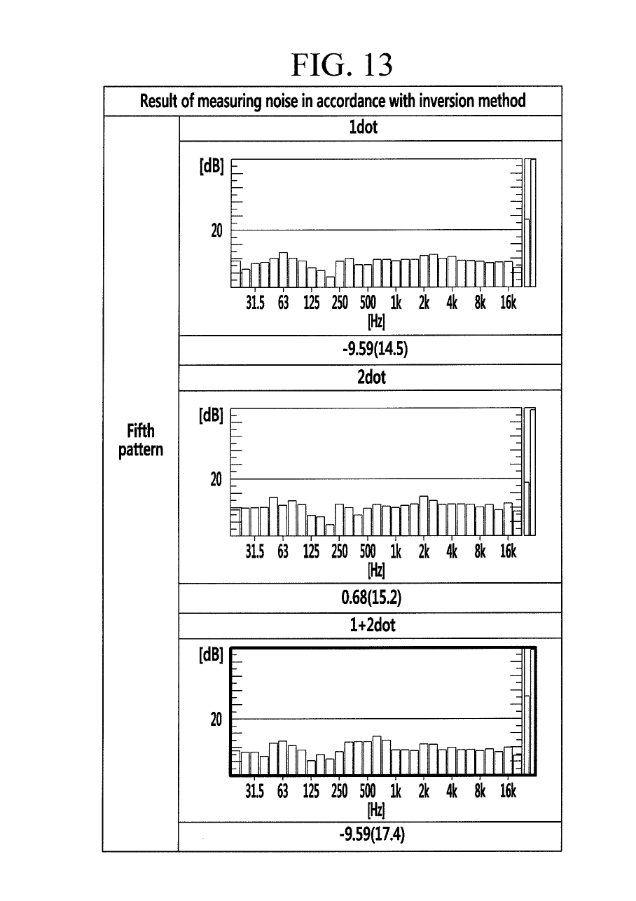

In the fifth image pattern of FIG. 12, the white and black are alternately displayed every one pixel row. A result of testing the noise by applying polarity inversion to the fifth image pattern is shown in FIG. 13.

Referring to FIG. 13, the noise is lower than the reference value, and as a result, any of the inversion methods may be used. For example, if the 1+2dot inversion method is used as the default, the inversion method does not need to be changed.

In FIGS. 4 to 13, the noise can be significantly reduced by changing the inversion method for each image pattern and the noise can be reduced by changing the inversion method for various image patterns by accumulating data through tests for patterns other than the image pattern provided in this application.

The ‘five image patterns’ of FIGS. 4, 6, 8, 10, and 12 have a structure in which the white and black are repeated for pixel rows of a predetermined number. However, for a pattern in which the number of the pixel rows displaying the white and black is unspecific, the noise may be generated in some of the inversion methods. The noise can be reduced by examining and applying an appropriate inversion method to the pattern.

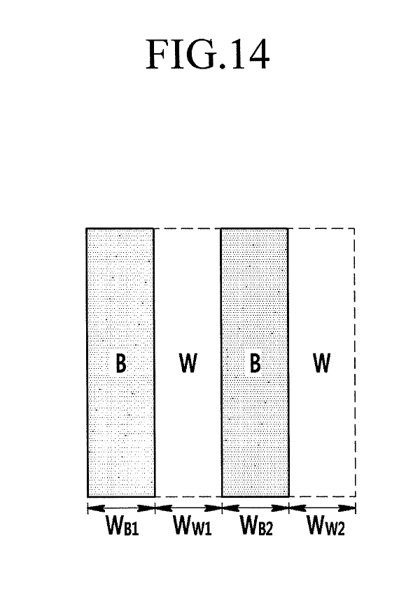

The image pattern shown in FIG. 14 has a structure in which white and black patterns elongate in a vertical direction unlike FIGS. 4, 6, 8, 10, and 12. For example, the image pattern is a pattern in which white and black pixel columns alternate with one another. In FIG. 14, the widths of the columns are represented by W_{B1}, W_{W1}, W_{B2}, and W_{W2}.

Since the noise may be generated in some inversion methods even in the pixel column type pattern shown in FIG. 14, an appropriate inversion method is selected and implemented to reduce noise of the display device through a test for each pattern.

In FIGS. 4, 6, 8, 10, 12, and 14, only the image patterns in which the white and black are repetitively displayed on the row or column are shown, and as a result, the image pattern may be sufficiently verified by discriminating whether data of one row or one column are the black or white. However, since the pattern generating noise is not actually limited to the black/white image pattern as described above, a more complicated data judgment procedure may be required.

Further, in an exemplary embodiment of the present invention, the inversion method can be determined and the noise can be reduced through the following method.

Whether the noise is generated can be indirectly judged based on whether a variation in the size of the data is large or small by applying a default gray inversion method to input image data. The inversion method is changed to prevent the noise from being generated. For example, since the reason for reducing the noise is variation in the size of the data voltage to which the inversion method is applied, the variation in the data voltage is predicted based on input data. When the variation in the magnitude of the data voltage, which is equal to or larger than a reference value, occurs at a predetermined frequency or more, it is predicted that the noise will increase and the inversion method is changed.

Further, embodiments of the present invention may be performed by an automatic inversion method in which an appropriate inversion method is determined from various gray inversion methods by analyzing the input image data and displaying the image data of the corresponding inversion method.

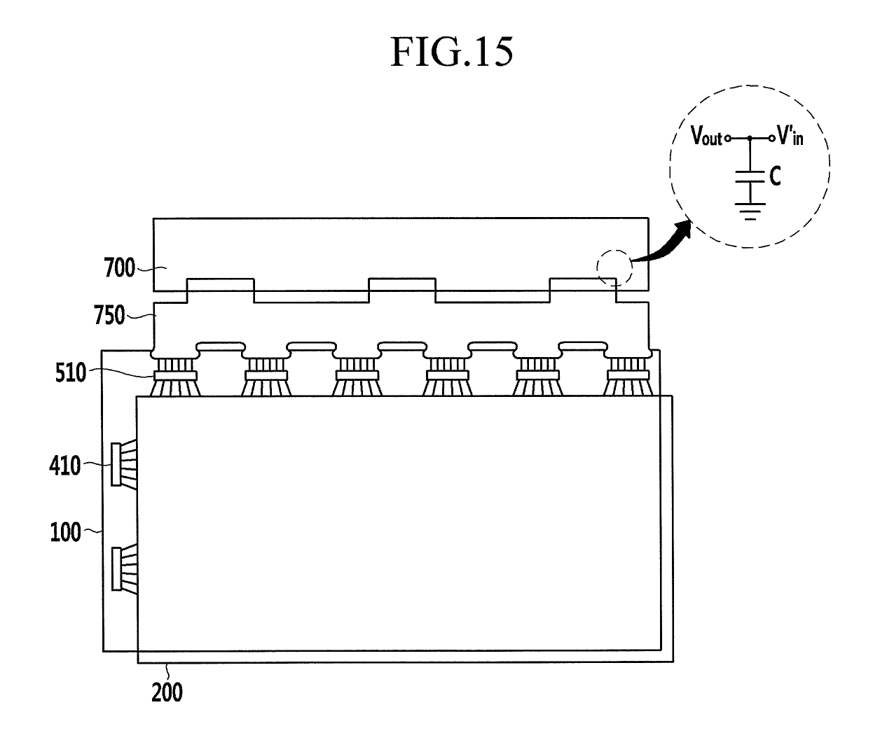

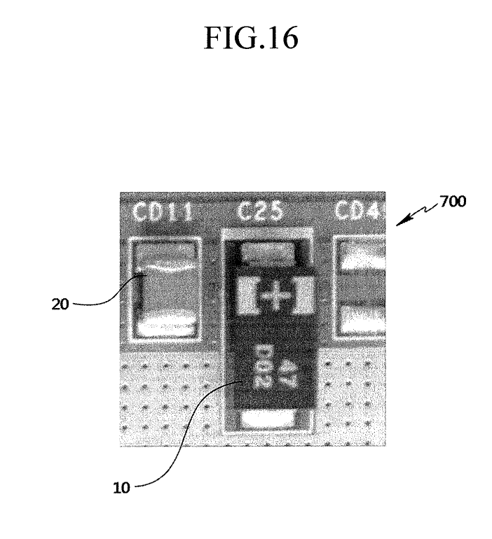

FIG. 15 is a diagram schematically showing a position where a capacitor generating noise is formed in a display device. FIG. 16 is photograph of capacitors that may correspond to the capacitor of FIG. 15. The display device of FIG. 15 may use one of the above-described noise reduction methods.

FIG. 15 shows an example in which the block diagram of FIG. 1 is implemented. The relationship between FIGS. 1 and 15 will be schematically described below.

The drivers 400, 500, 600, and 800 of FIG. 1 may be mounted directly on the panel assembly 300 in at least one integrated circuit chip, mounted on a flexible printed circuit film 750 to be attached to the liquid crystal panel assembly 300 in the form of a tape carrier package (TCP), or mounted on an additional printed circuit board 700. In an alternate embodiment, each of the drivers 400, 500, 600, and 800 may be integrated on the liquid crystal panel assembly 300 together with the gate lines G1 to Gn, data lines D1 to Dm, and thin film transistor switching elements. Further, the drivers 400, 500, 600, and 800 may be integrated as a single chip.

For example, the signal controller 600 may be formed on the printed circuit board 700, and the gate driver 400 and the data driver 500 may be directly mounted on the panel assembly 300. In FIG. 15, several data driving ICs 510 are joined together and may correspond to the data driver 500 of FIG. 1 and several gate driving ICs 410 are joined together and may correspond to the gate driver 400 of FIG. 1.

The signal controller 600 (not shown in FIG. 15) may be positioned on the printed circuit board 700 and connected with the data driving IC 510 and the gate driving IC 410 through the flexible printed circuit film 750.

The stacked capacitor, which may generate noise, may be foamed to constantly maintain an input/output signal at input and output terminals of each circuit and to reduce a ripple. In FIG. 15, the stacked capacitor is schematically shown in a circle. FIG. 15 does not show an actual circuit structure, but shows a structure in which one end is connected with a port through which an output voltage Vout and an input voltage Vin′ are output or input, and the other end is grounded. A plurality of capacitors having the input/output terminal are formed on the printed circuit board 700 and may cause vibration and noise.

FIG. 16 is a photograph showing a multi-layered ceramic capacitor and a polymer tantalum condenser attached to a printed circuit board 700.

In the exemplary embodiment of the present invention, the polymer tantalum condenser 10 or the stacked condenser such as the multi-layered ceramic capacitor 20 may be used as the capacitor. However, when the polymer tantalum condenser 10 is used, a manufacturing cost increases.

The multi-layered ceramic capacitor 20 or the polymer tantalum condenser 10 may be attached to the printed circuit board 700 of FIG. 15 as shown in the photograph of FIG. 16. However, in at least one embodiment of the invention, the polymer tantalum condenser 10 is not used in the display device.

While the invention has been described in connection with exemplary embodiments thereof, it is to be understood that the invention is not limited to the disclosed embodiments, but, on the contrary, is intended to cover various modifications and equivalent arrangements included within the spirit and scope of the disclosure.

What is claimed is:

1. A display device having a noise reduction function, comprising:
a display panel;
a data driver connected to the display panel;
a gate driver connected to the display panel; and
a signal controller controlling the data driver and the gate driver, and including an inversion determinator that is configured to select an inversion driving method based on an image pattern of input image data.

2. The display device of claim 1, wherein:
the inversion determinator includes,
a pattern verifying unit that is configured to verify whether the image pattern displayed by the image data is one of a plurality of image patterns; and
an inversion method determining unit generating and outputting an inversion control signal that corresponds to the verified image pattern to invoke the selected driving method.

3. The display device of claim 2, wherein:
the pattern verifying unit verifies whether one pixel row among the input image data displays black or white.

4. The display device of claim 3, wherein:
the signal controller further includes a plurality of line memories, and
a corresponding one of the line memories generates unit pixel row data corresponding to one pixel row by rearranging the image data input into the signal controller.

5. The display device of claim 4, wherein:
the pattern verifying unit verifies whether all the unit pixel row data are 1 or 0 to judge whether the data are black or white.

6. The display device of claim 3, wherein:
the inversion method determining unit stores the plurality of image patterns and corresponding inversion methods, and
when an image is displayed that is based on the verified image pattern generates a noise that is above a certain level by an inversion method stored as a default, the default inversion method is changed to one of the other inversion methods.

7. The display device of claim 6, wherein:
in one of the image patterns stored in the inversion method determining unit, the black and white are alternately displayed in rows.

8. The display device of claim 7, wherein:
in one of inversion methods, an inverted data voltage is applied every two rows from the first row to an image pattern in which the black and white are alternately displayed every four pixel rows or an image pattern in which the black and white are alternately displayed every two pixel rows among the stored image patterns.

9. The display device of claim 8, wherein:
the pattern verifying unit verifies the pattern by using only six consecutive rows.

10. The display device of claim 6, wherein:
in one of the image patterns stored in the inversion method determining unit, the black and white are alternately displayed in columns.

11. The display device of claim 1, further comprising:
a printed circuit board including a stacked capacitor,
wherein at least one of the signal controller and the data driver is disposed on the printed circuit board.

12. The display device of claim 11, wherein:
a polymer tantalum condenser is not disposed on the printed circuit board.

13. A noise reduction method, comprising:
receiving image data from the outside;
verifying whether an image pattern of the received image data corresponds to one of a plurality of stored image patterns; and
changing an inversion method to one of a plurality of inversion methods based on the verified image pattern.

14. The method of claim 13, wherein:
the verifying of the image pattern of the received image data includes,
measuring a variation amount of the received image data; and
verifying whether the image pattern of the image data exists among the stored image patterns in accordance with the measured variation amount.

15. The method of claim 13, wherein:
in the stored image patterns, black and white are alternately displayed in rows.

16. The method of claim 15, wherein:
in one of the inversion methods, an inverted data voltage is applied every two rows from the first row to an image pattern in which the black and white are alternately displayed every four pixel rows or an image pattern in which the black and white are alternately displayed every two pixel rows among the stored image patterns.

17. The method of claim 16, wherein:
in the verifying of the image pattern of the received image data, the pattern is verified using only six consecutive rows.

18. A display device, comprising:
a display panel to display images;
a data driver to provide data voltages to the display panel;
a gate driver to provide gate voltage to the display panel; and
a signal controller controlling the data driver and the gate driver,
wherein the signal controller stores a plurality of image patterns and corresponding inversion driving methods,
wherein the signal controller is configured to compare a source image pattern of input image data with the plurality of image patterns, select one of the inversion driving methods based on a result of the comparison, and drive the data driver based on the selected inversion driving method.

19. The display device of claim 18, wherein each image pattern includes alternating rows of black and white or alternating columns of black and white.

20. The display device of claim 19, wherein the driving methods are distinct from one another and the image patterns are distinct from one another.
